(19) United States
(12) Patent Application Publication
(10) Pub. No.: US 2025/0078110 A1
(43) Pub. Date: Mar. 6, 2025

(54) Michael Allen Xchange - Monetary Rewarding Advertising System for Digital Platforms

(71) Applicant: Michael Allen, Baltimore, MD (US)

(72) Inventor: Michael Allen, Baltimore, MD (US)

(21) Appl. No.: 18/949,953

(22) Filed: Nov. 15, 2024

(51) Int. Cl. G06Q 30/0207; G06Q 30/0251

(52) U.S. Cl. CPC G06Q 30/0224; G06Q 30/0225; G06Q 30/0255

(57) ABSTRACT

This invention is a system and method for incentivizing user interaction with digital advertisements by providing direct monetary compensation for valid clicks and engagements. The system includes measures for fraud detection, secure transaction processing, and a structured reward distribution system that maintains the quality of interactions while maximizing benefits for advertisers and users.

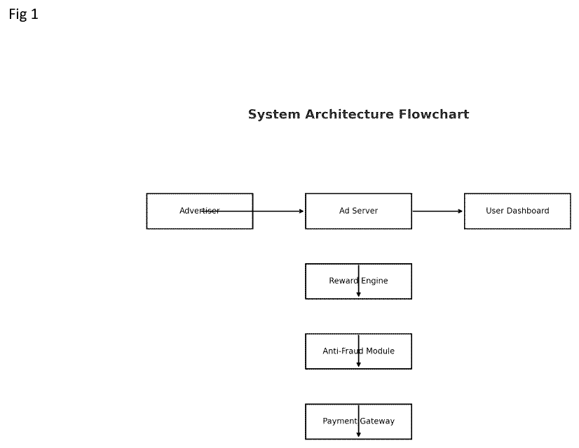

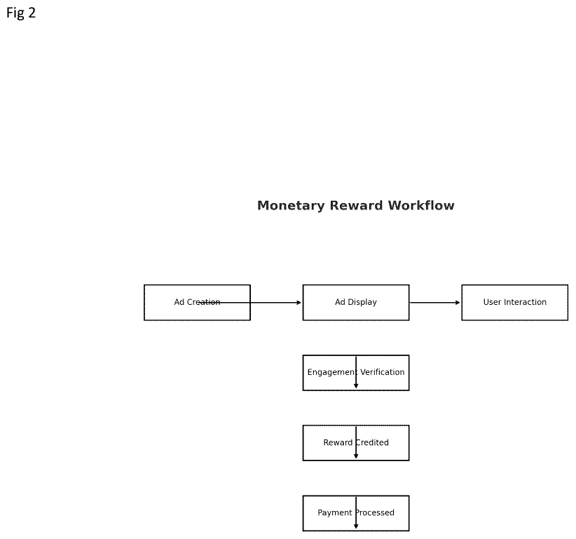

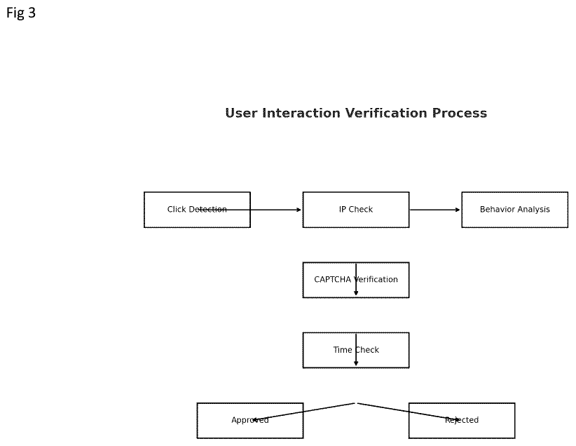

### BACKGROUND

Current advertising models face challenges in ensuring user engagement quality, often leading to inflated metrics and ineffective ad campaigns. This invention addresses these issues by directly rewarding users with money for verified clicks, promoting genuine engagement, and implementing robust anti-fraud mechanisms.

### SUMMARY OF THE INVENTION

The invention comprises:

A User Dashboard for tracking engagement, monetary earnings, and payment history.

An Ad Management System for advertisers to create and monitor ad campaigns.

A Monetary Reward Distribution System that calculates and processes payments to users for valid engagements.

Anti-Fraud Measures to ensure the authenticity of user interactions.

A Secure Payment Gateway to handle financial transactions for user payouts.

### DETAILED DESCRIPTION

### System Architecture

Ad Server: Distributes ads to users based on specific targeting criteria.

User Dashboard: An interface for users to track their monetary rewards, engagement history, and payout requests.

Reward Engine: Monitors user interactions and calculates cash payments based on predefined criteria.

Anti-Fraud Module: Uses IP monitoring, behavior analysis, and engagement metrics to validate legitimate clicks.

Payment Gateway: Processes and transfers monetary rewards to user accounts securely.

### Workflow

Ad Creation: Advertisers create an ad campaign, choosing ad type, audience, bid per click, and budget.

Ad Display: The ad is served to targeted users on the digital platform.

User Interaction: Users engage with the ad by clicking, viewing, or performing a required action.

Verification: The system validates the click using anti-fraud tools to determine eligibility for payment.

Monetary Reward Distribution: Upon successful verification, the cash reward is credited to the user's account.

Payment Processing: Users request payouts once they meet a minimum earnings threshold

1. A method for rewarding users on a digital platform with monetary compensation for engaging with advertisements, including displaying targeted ads, tracking and verifying user interactions using anti-fraud mechanisms, crediting verified engagements with cash rewards, and securely processing payouts.

2. The system as described in claim 1, including a user dashboard that tracks monetary earnings, engagement history, and payout requests.

3. The system as described in claim 1, wherein the anti-fraud system validates user interaction based on engagement time, click patterns, and user behavior.

4. The system as described in claim 1, wherein a payment gateway handles all user withdrawals securely, ensuring that transactions are compliant with financial regulations.
